(19) United States
(12) Patent Application Publication
(10) Pub. No.: US 2005/0113232 A1
(43) Pub. Date: May 26, 2005

(54) Method of and apparatus for making a non-wrapped filter rod in the field of the tobacco processing industry

(75) Inventors: Stephan Wolff, Glinde (DE); Thorsten Scherbarth, Geesthacht (DE); Sonke Horn, Geesthacht (DE); Irene Maurer, Hamburg (DE); Alexander Buhl, Robertsdorf (DE); Jann De Boer, Hamburg (DE)

Correspondence Address: VENABLE, BAETJER, HOWARD AND CIVILETTI, LLP, P.O. BOX 34385, WASHINGTON, DC, 20043-9998, US

(73) Assignee: Hauni Maschinenbau AG, Hamburg (DE)

(21) Appl. No.: 10/986,832

(22) Filed: Nov. 15, 2004

(30) Foreign Application Priority Data
Nov. 21, 2003 (DE) 103 54 797.5

(51) Int. Cl. B31C 13/00

(52) U.S. Cl. 493/39

(57) ABSTRACT

A method of making a non-wrapped filter rod in the field of the tobacco processing industry, includes the steps of applying filter material to a forming belt where the filter material is substantially fully separated prior to being applied to the forming belt; shaping the filter material in a forming apparatus into the filter rod; and exposing the formed filter rod in the forming apparatus to energy to obtain a bond of the filter material. In addition, an apparatus for making a non-wrapped filter rod includes a fiber shower-producing apparatus where substantially fully separated fibers of a filter material may be accumulated to form a non-woven web; and a forming apparatus having a moveable forming belt for receiving the separated fibers of the filter material where the forming belt is capable of being wound about filter material of finite length to produce a filter rod.

### CROSS-REFERENCE TO RELATED APPLICATION

This application claims the priority of German Patent Application No. 103 54 797.5, filed on Nov. 21, 2003, the subject matter of which is incorporated herein by reference.

### BACKGROUND OF THE INVENTION

The invention relates to a method of making a non-wrapped filter rod in the field of the tobacco processing industry, according to which filter material is positioned on a forming belt and is formed into a (continuous) filter rod or filter strand via a forming apparatus. The filter rod is, in the forming apparatus or downstream thereof as viewed in the advancing direction of the filter material, exposed to energy for bonding the filter material.

The invention further relates to an apparatus for making a non-wrapped filter rod in the field of the tobacco processing industry, comprising a forming apparatus in which a forming belt is movable which may be wound about the filter material comprising fibers of finite length.

The invention further relates to a forming apparatus in the field of the tobacco processing industry, including a lower forming component and an upper forming component. The forming apparatus has an inlet region and is further structured to wind a forming belt, movable through the forming apparatus, about a material, particularly filter material, in the field of the tobacco processing industry.

A method and an apparatus of the above-outlined type are described in U.S. Pat. No. 3,377,220. With particular reference to FIG. 11 and the pertaining description in this patent document, a filter acetate rod of indefinite length is comminuted in an appropriate apparatus and is applied by means of an air stream to an air-pervious forming belt in a forming apparatus. In the region of the forming apparatus, steam is admitted to the filter material for bonding the same.

### SUMMARY OF THE INVENTION

It is an object of the invention to provide a method and an apparatus with which a highly homogeneous rod of material in the field of the tobacco processing industry, particularly a filter rod, may be formed. This object is achieved by a method of making a non-wrapped filter rod or filter strand in the field of the tobacco processing industry, which includes the steps of applying filter material to a forming belt where the filter material is substantially fully separated prior to being applied to the forming belt; shaping the filter material in a forming apparatus into the filter rod; and exposing the formed filter rod in the forming apparatus to energy to obtain a bond of the filter material.

A substantially full separation of the filter material, prior to applying it to a forming belt, enables a highly homogeneous filter rod to be formed.

In this connection, reference is made in particular to the present assignee's European Patent Applications EP 03 007 675.6 and EP 03 007 672.3, both filed on Apr. 3, 2003 and both are, in their entirety, incorporated herein by reference. It is essential according to the invention that the filter materials which preferably include fibers of finite length, are substantially fully separated. As an analogy, the visual appearance of a stream of separated fibers is similar to a snow storm, that is, a stream of fibers which has a homogeneous statistic fiber distribution both in space and in time. In particular, a substantially full fiber separation means a substantial absence of any group of interconnected fibers. Only after a separation of fibers is a fiber bond produced, for example, in the filter rod. In this manner a filter rod can be obtained which contains neither bridges nor hollow spaces.

The separated fibers are preferably advanced by an air stream, so that the separated fibers may be transported without forming fiber groups. The separation is performed preferably by an air stream, resulting in a very high degree of separation.

The filter materials may be those disclosed in the above-identified patent applications. Also, filter materials may be used which are noted, for example, in the present assignee's European Patent Application 03 004 594.2. In particular, these materials are multi-component fibers having a length of between 0.5 mm and 30 mm, preferably between 2 mm and 8 mm and particularly preferably between 3 mm and 6 mm. In the multi-component fiber preferably a core and a sleeve are provided which are of unlike material. The sleeve material has a lower melting point than that of the core material. Other filter materials may also be added, such as active carbon granules or cellulose fibers. European Patent Application 03 004 594.2 is likewise incorporated herein by reference in its entirety.

The term “non-wrapped filter rod” is defined as meaning a filter rod which is not wrapped in a sleeve strip, such as a filter paper strip. Thus, a non-wrapped filter rod is a filter rod which has no sleeve material, in particular no filter paper strip.

The homogeneity of the filter rod is increased by first forming, after a separation of the filter material, a non-woven filter material or non-woven web which is subsequently deposited on the forming belt. The non-woven web is expediently formed in a suction belt conveyor which includes at least one suction belt on which the non-woven web is accumulated.

It is particularly preferred to pre-form the filter material deposited on the forming belt by means of at least one chamfered disk. In this manner, the cross section of the filter material may be reduced highly uniformly and with low friction as the forming belt is wound or partially wound about the filter material, thus providing for an efficient manufacturing process. Preferably two disks are used whose chamfer, in particular, border one another. A particularly homogenous filter rod formation is obtained if the disks are swash plates.

According to an expedient feature of the invention, the energy for bonding the fibers to one another is microwave energy or hot air. A particularly rapid manufacturing process may be ensured by cooling the filter rod subsequent to exposure to energy. The handling properties of the filter elements severed from the filter rod is improved by providing the rod with a curable jacket of a liquid material. In this manner, after making the filter rod or filter stand, an outer skin may be applied thereto. This may be obtained by submersion or by spraying with a curable material, such as a hot-melt adhesive, a starch-containing adhesive, polypropylene or the like.

Subsequent to the above-described method, the obtained filter rod may be severed into filter elements, a manufacturing process for filter elements according to the invention is obtained.

Further, the object of the invention for making a non-wrapped filter rod in the field of the tobacco processing industry is achieved by an apparatus which includes a forming apparatus in which a forming belt is movable. The forming belt may be wound about the filter material which contains fibers of finite length. Further, upstream of the forming apparatus, a fiber shower-producing apparatus is provided to form a non-woven web from the substantially fully separated fibers. The apparatus according to the invention does not need a sleeve strip-feeding or sleeve-feeding arrangement and, accordingly, a sleeve-transporting arrangement is also dispensed with. Thus, the forming belt directly borders the filter material which may be deposited on the forming belt.

That is, the object to the invention can be achieved by an apparatus for making a non-wrapped filter rod in the field of the tobacco processing industry which includes a fiber shower-producing apparatus where substantially fully separated fibers of a filter material may be accumulated to form a non-woven web; and a forming apparatus having a moveable forming belt for receiving the separated fibers of the filter material where the forming belt is capable of being wound about filter material of finite length to produce a filter rod.

By means of the apparatus according to the invention, a highly uniform and homogeneous filter rod may be produced.

The fiber shower-producing apparatus preferably includes a suction belt conveyor. By providing at least one chamfered disk in the region of the forming apparatus, a highly uniform pre-forming of the filter rod, that is, of the non-woven material or non-woven web, is feasible. Within the meaning of the invention, the term “disk” also encompasses the term “roll”. The chamfered disk is preferably rotatable, and the periphery of the disk moves in the advancing direction of the forming belt, that is, in the advancing direction of the filter material. The chamfered disk serves for pre-forming the non-woven web in preparation for the eventual formation of the filter rod in the forming apparatus.

Preferably an operative connection is provided with the forming belt by catching and progressively bending the forming belt inward by the chamfer. The shape of the chamfer is preferably at least partially circular or elliptical: preferably a quarter circle or a quarter ellipse is provided. An arrangement is of particular advantage where two chamfered disks are provided which, in particular, rotate about the same rotary axis and whose chamfers border one another. By providing that at least one, but preferably both disks are swash plates, a particularly effective pre-forming of the non-woven web may be performed. The swash plates are preferably inclined toward one another in the feeding direction. Within the meaning of the invention, a swash plate is an obliquely oriented disk which is not perpendicular to its drive shaft.

An effective bonding of the filter materials is feasible by providing a unit for applying energy to the filter material. The unit is preferably arranged in the region of the forming apparatus. Advantageously, the energy is applied as microwaves or hot air.

The filtering properties of the filter rod may be improved by providing a wrapping apparatus by means of which an outer skin is applied to the filter rod. A highly effective and uniform filter rod formation is possible by providing that the width of the forming belt at least equals the circumference of the filter rod to be produced. In case the width of the forming belt equals the circumference of the filter rod to be produced, a filter rod formation with a very small seam is possible. In case of a width that is greater than the circumference of the filter rod to be made, an overlapping of the forming belt in the forming apparatus takes place.

The object of the invention is further achieved by a forming apparatus in the field of the tobacco processing industry, including a lower forming device and an upper forming device, as well as an inlet region. The forming apparatus is structured such that a forming belt which is movable through the forming apparatus, may be wound about a material, particularly a filter material in the field of the tobacco processing industry. In the inlet region, a rotatably supported disk pair is arranged for progressively bending at least one part of the forming belt.

The forming apparatus according to the invention provides for a highly uniform rod formation.

The disk pair is preferably a swash plate pair. According to an advantageous feature, the shafts of the disks are coaxial. According to another preferred feature, a common rotary shaft is provided for the disks.

By providing the disks with a chamfer along their periphery, a particularly effective pre-forming of the filter rod is feasible. For this purpose, preferably at least one part of the chamfer is a partial circle, particularly a quarter circle. In case a filter rod of elliptical cross section is desired, the chamfer may comprise at least a partial ellipse, particularly a quarter ellipse.

In the present invention, the term “chamfer” is defined to mean a shape of the circumferential disk surface which in cross section is not a straight line oriented perpendicularly to at least one end face. Instead of a chamfer, a hollowed-out or milled-out portion may be provided.

The object of the invention is further achieved by the use of a swash plate pair in the region of a forming apparatus in the field of the tobacco processing industry for bending a forming belt. Such a bending is preferably effected transversely to the transporting direction of the forming belt.

### BRIEF DESCRIPTION OF THE DRAWINGS

The invention will be described below with reference to several embodiments in conjunction with the drawings, without limiting the general scope of the invention. Reference is expressly made to the drawings as concerns all inventive details not included in the description. In the drawings:

FIG. 1 is a schematic side elevational view of a rod-making machine according to the invention;

FIG. 2 is a schematic sectional view of the rod-making machine of FIG. 1, as viewed in the direction of arrow A of FIG. 1;

FIG. 3 is, in the upper drawing zone, a schematic top plan view of a forming apparatus according to the invention and, in the lower drawing zone, for a better illustration, a top plan view of a forming belt movable through the forming apparatus;

FIG. 4 is, in the upper drawing zone, a schematic side elevational view of a forming apparatus of FIG. 3, and, in the lower drawing zone, for a better illustration, a schematic side elevational view of the forming belt of FIG. 3;

FIG. 5 is a schematic sectional view along line A-A of FIG. 4; and

FIG. 6 is a schematic sectional view along line B-B of FIG. 4.

### DETAILED DESCRIPTION OF THE INVENTION

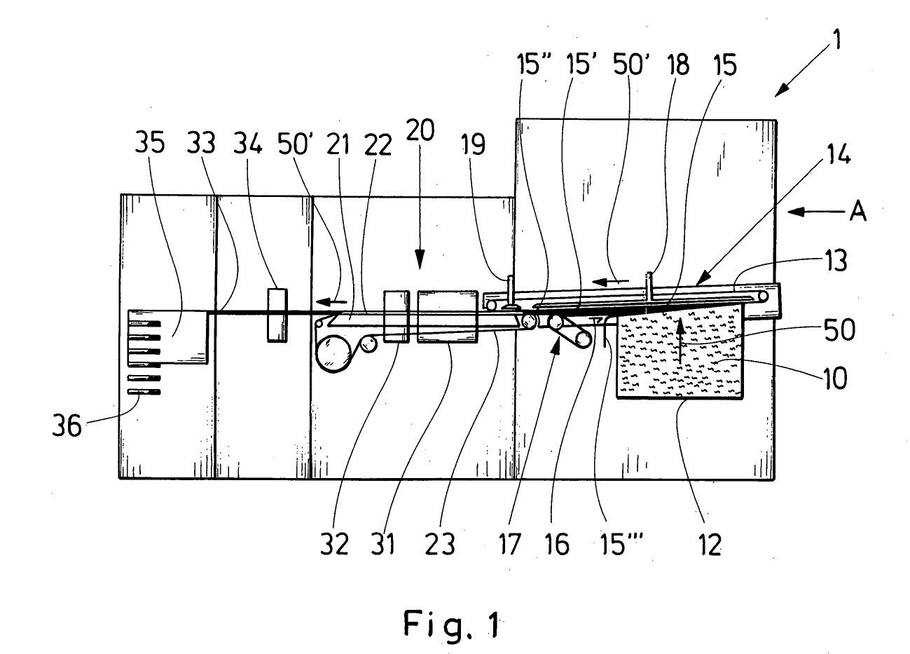

FIG. 1 shows a schematic side elevational view of a rod-making machine 1 according to the invention. The rod-making machine 1 essentially corresponds to the rod-making machine described in European Patent Applications 03 007 675.6 and 03 007 672.3, except that the filter rod-making machine 1 is capable of manufacturing a filter rod without a sleeve strip.

As disclosed in the above-identified European patent applications, fibers 10 a of finite length are substantially fully separated and advanced by transporting air in the feed direction 50 above a fluidized bed 12 toward a suction belt 13 of a suction belt conveyor 14. The separated fibers 10 are showered onto the suction belt 13 and form a leftward-increasing (as viewed in FIG. 1) fiber layer 15 in the channel of the suction belt conveyor 14 on the leftward-moving suction belt 13 as viewed in FIG. 1. The fiber layer 15 increases in the feed direction 50′ and is, while being conveyed in the feed direction 50′, leveled at a trimmer 16. After trimming, a trimmed fiber layer 15′″ is transported away. The fiber layer 15′ remaining on the suction belt 13 is, after trimming, densified in a pressing device 17. In the presently described embodiment, the pressing device is a conveyor belt which includes a pressure roll. The conveyor belt or, as the case may be, the pressure roll is moved in the feed direction, that is, counterclockwise, as viewed in FIG. 1.

After leveling and densification, a transfer of the densified fiber layer 15″ is effected from the suction belt conveyor 14 to a forming apparatus or forming garniture 20. In the present embodiment, the fiber layer may be a non-woven fiber web. For accumulating the fiber layer on the suction belt 13, a vacuum stream is used which affects the suction belt 13 by means of a vacuum nipple 18. In the region of transfer of densified fiber layer 15″ to the forming apparatus, a pressurized air nipple 19 is provided, by means of which the densified fiber layer 15′″ is taken off the suction belt 13 and placed on the forming belt 23 of the forming apparatus 20.

The forming apparatus or forming garniture 20 comprises a forming console 21, a forming assembly 22 and the forming belt 23. Additional components of the forming apparatus 20 will be described in further detail as the specification progresses. The filter rod 33 formed in the forming apparatus 20 is optionally sprayed by a spraying unit 34, for example, with polypropylene to provide a jacket or outer skin on the filter rod 33. The filter rod 33 is subsequently admitted to a cutting apparatus 35 which severs filter rods 36 from the filter rod 33.

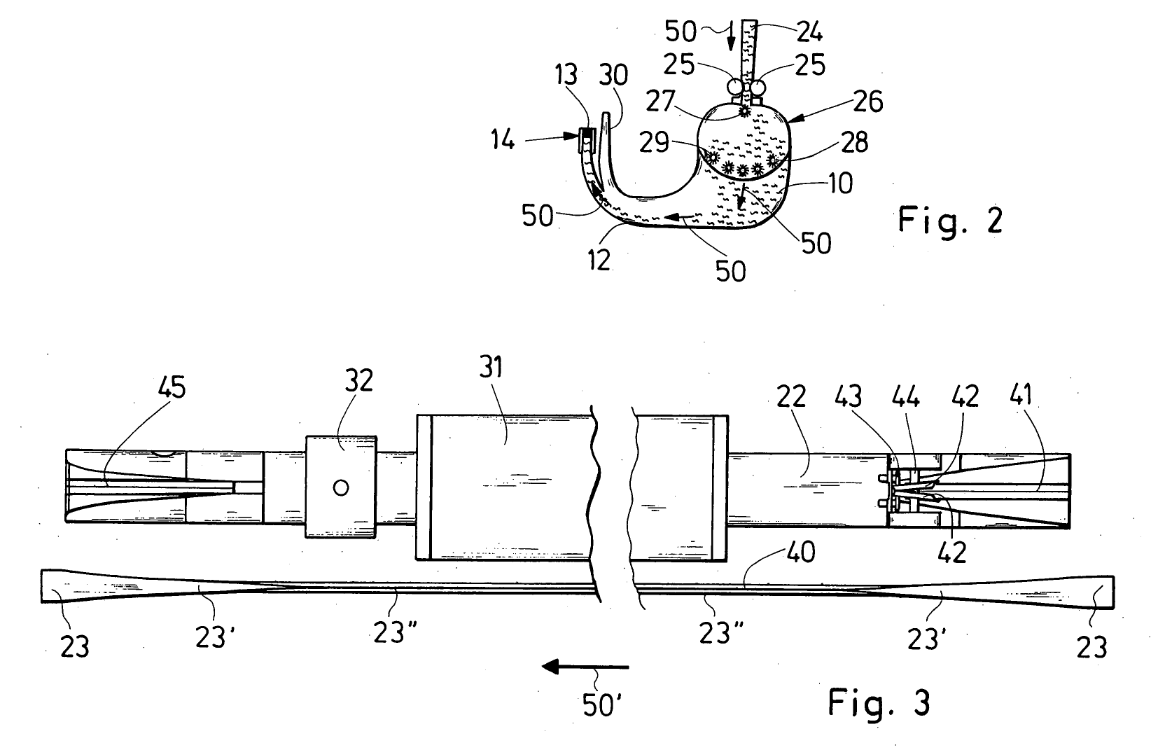

FIG. 2 shows, in a schematic side elevational view, a portion of the rod-making machine according to an embodiment of the invention as viewed in the direction of the arrow A of FIG. 1. In FIG. 2, the separation of the fibers 10 and the feed of the separated fibers 10 to the suction belt conveyor 14 is schematically illustrated. The separation corresponds, for example, to that described in European Patent Applications 03 007 675.6 and 03 007 672.3. All kind of separation described in these two European patent applications may be utilized.

Fibers are introduced into an accumulation chute 24. Two intake rolls 25 advance the fibers to the working zone of a transporting roll 27 which hurls the fibers from the accumulation chute 24. In the separating apparatus 26, separating rolls 28 are provided which are operatively coupled to a screen 29. By means of the conveying air stream which is not shown in FIG. 2 (in this connection reference is made to the earlier-mentioned European patent applications) and the separating rolls 28, the fibers, which became substantially fully separated, are delivered through the screen 29 so that essentially separated fibers are present in the region of the fluidizing bed 12. The essentially separated fibers are admitted in a separated condition from the region of the fluidizing bed 12 to the suction belt 13 of the suction belt conveyor 14. This may be achieved via the means of a conveying air stream, particularly when the air stream is under substantially continuous acceleration. Excess transporting air may be removed through a vacuum or suction nipple 30 or through a non-illustrated space of the fluidizing bed 12.

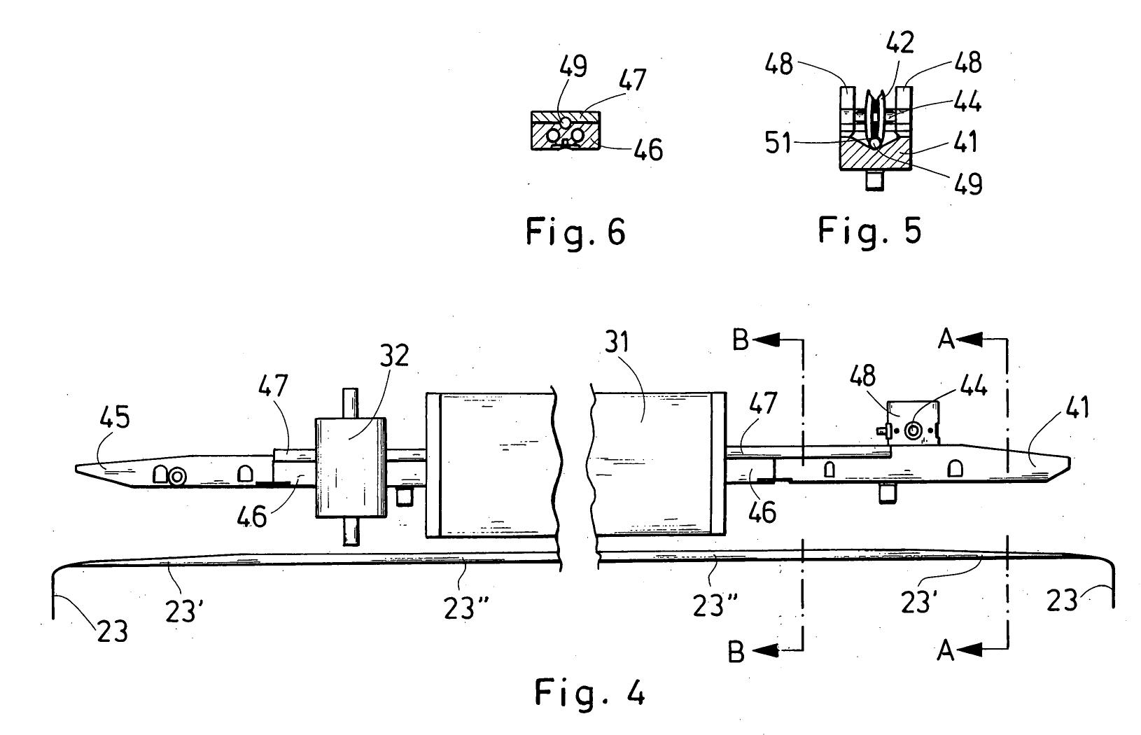

FIG. 3 is a top plan view and FIG. 4 is a side elevational view of a forming apparatus according to an embodiment of the invention that forms a part of the rod-making machine 1 according to the invention. In FIGS. 3 and 4, the forming belt 23 is, for better visibility, shown externally of, and parallel to, the forming assembly 22. The latter comprises an inlet chamber 41, a lower forming bed 46, an upper forming cover, upper forming device or upper forming mold 47, a microwave unit 31, a cooling unit 32 and an outlet chamber 45.

The forming belt 23 is moved counterclockwise in the feed direction 50′. Upstream of the inlet chamber 41 and downstream of the outlet chamber 45, the forming belt 23 is linearly guided. In the inlet chamber 41, the forming belt 23′ is, in a laterally progressive manner, deformed upward to assume a circular shape. At the end of the inlet chamber 41 the upward bent sides of the forming belt 23′ are grasped and bent progressively inward by a pair of swash plates 42. After leaving the working region of the swash plate pair 42, the forming belt 23′ is already almost fully round. A complete rounding of the forming belt 23″ occurs between the lower forming bed 46 and the upper forming cover 47. The side edges of the forming belt 23″ are either in an abutting or in an overlapping position. Preferably, the side edges of the forming belt 23″ abut one another, whereby a seam 40 is obtained. In such a case, the width of the forming belt equals the circumference of the filter rod to be produced. After passing through the lower forming bed 46, the upper forming cover 47, the microwave unit 31 and the cooling unit 32, the forming belt 23″ arrives in the outlet chamber 45, where the forming belt 23′ is deformed back to regain its linear form 23.

Two deflecting rolls 43 are provided at the end of the inlet chamber 41 for guiding the swash plates 42. The latter are affixed on a shaft 44, which rotates the swash plates 42. Further, side walls 48 are provided, which support shaft 44.

FIG. 5 is a schematic sectional view taken along line A-A of FIG. 4. In particular, swash plates 42 are clearly shown, which at least partially produce the rod cross section 49 in the lower region against a respective chamfer 51. FIG. 6 is a schematic sectional view along line B-B of FIG. 4. At that location, the filter rod has already been fully formed. The filter rod or the fibers in the filter rod have, however, not yet formed a fully firm bond.

In the region of the inlet chamber 41, the densified fiber layer 15″ is transferred from the suction belt conveyor 14 to the forming belt 23′. During the rounding of the forming belt 23′, 23″, the densified fiber layer 15″ transferred to the forming belt 23′ is held circularly enclosed by the forming belt 23″. The latter holds and advances the filter rod 33 through the microwave unit 31. The binding fibers of the filter rod 33 are melted by the effect of microwaves in the microwave unit 31 to fuse them to one another, together with fill fibers. Binding fibers, particularly bi-component fibers, are used that have a core and a jacket. The jacket has a material of lower melting point than that of the core. In this connection, particular reference is made to European Patent Application 03 004 594.2. As fill fibers, for example, cellulose fibers are adapted for use. These fibers too, are disclosed in European Patent Application 03 004 594.2. The advantage of using a microwave unit 31 resides in the only a slight heat-up of the filter rod 33 occurs so that a forming belt cooling, which is a contact cooling, is sufficient.

Fiber rod 33 initially passes through the microwave unit 31, which may be arranged according to the principle of contact cooling, and then fiber rod 33 passes through a cooling unit 32. Cooling unit 32 guides cooling water through the upper forming cover 47 and the lower forming bed 46 so that molten regions of the fiber rod are cooled and cured, resulting in a hardened fiber rod 33. The type, material and properties of the forming belt 23 are selected so that a fusion of the binding fibers with the forming belt is not possible. The forming belt is preferably air-pervious. Upon deforming the forming belt at 23″ into 23′ and subsequently into 23, the cured fiber rod 33 preserves its approximately circular shape. An oval or elliptical fiber rod 33 may be formed as well. For this embodiment, the forming apparatus or forming assembly 22 would have an oval or elliptical configuration.

The forming belt 23′ frees the fiber rod laterally and upward and advances it to the cutting apparatus 35 where the cured fiber rod 33 is severed into filter rods 36. Prior to severing into filter rods 36, a sleeve material may be applied about the fiber rod 33 in a spraying unit 34 (which may be an immersion bath). The sleeve material may be, for example, a hot-melt adhesive.

The chamfer 51 of the swash plates is configured to correspond to the desired shape of the filter rod to be obtained.

The invention has been described in detail with respect to exemplary embodiments, and it will now be apparent from the foregoing to those skilled in the art, that changes and modifications may be made without departing from the invention in its broader aspects, and the invention, therefore, as defined in the appended claims, is intended to cover all such changes and modifications that fall within the true spirit of the invention.

1. A method of making a non-wrapped filter rod in the field of the tobacco processing industry, comprising the steps of:
applying filter material to a forming belt, the filter material being substantially fully separated prior to being applied to the forming belt;
shaping the filter material in a forming apparatus into the filter rod; and
exposing the formed filter rod in the forming apparatus to energy to obtain a bond of the filter material.

2. The method as defined in claim 1, further comprising the step of forming the substantially fully separated filter material initially into a non-woven material and subsequently depositing the non-woven material on the forming belt during the applying step.

3. The method as defined in claim 2, wherein the forming step occurs in a suction belt conveyor so that the non-woven material is formed in a suction belt conveyor.

4. The method as defined in claim 1, wherein the step of forming the substantially fully separated filter material into a non-woven material includes pre-forming the filter material on the forming belt by using at least one chamfered disk.

5. The method as defined in claim 4, wherein the at least one chamfered disk is two chamfered disks and a chamfer of each chamfer disk borders a chamfer of the other chamfered disk.

6. The method as defined in claim 5, wherein the chamfered disks are swash plates.

7. The method as defined in claim 1, wherein the energy is one of microwave energy or hot air.

8. The method as defined in claim 1, further comprising cooling the formed filter rod after the filter rod is exposed to the energy.

9. The method as defined in claim 1, further comprising the step of providing the filter rod with a curable jacket made of a liquid material.

10. A method of making a filter element in the field of the tobacco processing industry, including a method as defined in claim 1, further comprising the step of subsequently severing the formed and bonded filter rod into filter elements.

11. An apparatus for making a non-wrapped filter rod in the field of the tobacco processing industry, comprising:
a fiber shower-producing apparatus where substantially fully separated fibers of a filter material may be accumulated to form a non-woven web; and
a forming apparatus having a moveable forming belt for receiving the separated fibers of the filter material, the forming belt capable of being wound about filter material of finite length to produce a filter rod.

12. The apparatus as defined in claim 11, wherein the fiber shower-producing apparatus includes a suction belt conveyor.

13. The apparatus as defined in claim 11, wherein the forming apparatus includes at least one chamfered disk.

14. The apparatus as defined in claim 13, wherein the forming apparatus includes two chamfered disks.

15. The apparatus as defined in claim 13, wherein at least one chamfered disk is a swash plate.

16. The apparatus as defined in claim 11, further comprising a unit for supplying energy to the formed filter material.

17. The apparatus as defined in claim 16, wherein the energy is supplied in the form of one of microwaves or hot air.

18. The apparatus as defined in claim 11, further comprising a jacket-forming apparatus which applies an outer skin to the filter material forming a filter rod.

19. The apparatus as defined in claim 11, wherein the width of the forming belt at least equals the circumference of the filter rod to be produced.

20. A forming apparatus in the field of the tobacco processing industry, comprising:
an inlet region for receiving material;
a lower forming bed and an upper forming device respectively disposed throughout the forming apparatus; and
a forming belt, movable through the forming apparatus, about a material, wherein the inlet region has a pair of rotatably supported disks for progressively bending at least one part of the forming belt.

21. The forming apparatus as defined in claim 20, wherein the disk pair is a swash plate pair.

22. The forming apparatus as defined in claim 20, wherein each rotatably supported disk has a rotary shaft and the rotary shafts of the disks are coaxial.

23. The forming apparatus as defined in claim 20, wherein the rotatably supported disks share a common shaft.

24. The forming apparatus as defined in claim 20, wherein the disks are chamfered at their respective circumferential surface.

25. The forming apparatus as defined in claim 24, wherein at least one part of the chamfer is a partial circle.

26. The forming apparatus as defined in claim 25, wherein the partial circle is a quarter circle.

27. The use of a swash plate pair in the region of a forming apparatus in the field of the tobacco processing industry for bending the forming belt moving in a feed direction.

28. The use as defined in claim 27, wherein the bending of the forming belt is transverse with respect to the feed direction of the forming belt.
